(19) United States
(12) Patent Application Publication
(10) Pub. No.: US 2025/0267755 A1
(43) Pub. Date: Aug. 21, 2025

(54) ENHANCEMENTS FOR CELL DTX CONFIGURATION AND ADAPTATION

(71) Applicant: QUALCOMM Incorporated, San Diego, CA (US)

(72) Inventors: Xiao Feng WANG, San Diego, CA (US); Peter GAAL, San Diego, CA (US); Le LIU, San Jose, CA (US); Alberto RICO ALVARINO, San Diego, CA (US); Hung Dinh LY, San Diego, CA (US)

(21) Appl. No.: 18/979,498

(22) Filed: Dec. 12, 2024

Related U.S. Application Data
(60) Provisional application No. 63/554,143, filed on Feb. 15, 2024.

(51) Int. Cl. H04W 76/28; H04W 72/232

(52) U.S. Cl. CPC H04W 76/28; H04W 72/232

(57) ABSTRACT

A UE receives an indication of multiple discontinuous transmission (DTX) configurations for a cell. The UE receives an activation indication for a first DTX configuration from the multiple DTX configurations for the cell. The UE skips monitoring for a physical downlink control channel (PDCCH) during a non-active period of the first DTX configuration.

### CROSS REFERENCE TO RELATED APPLICATION(S)

This application claims the benefit of and priority to U.S. Provisional Application Ser. No. 63/554,143, entitled “Enhancements for Cell DTX Configuration and Adaptation” and filed on Feb. 15, 2024, which is expressly incorporated by reference herein in its entirety.

### INTRODUCTION

The present disclosure relates generally to communication systems, and more particularly, to wireless communication that includes discontinuous transmission (DTX).

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR and/or future wireless communication technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In some aspects, the techniques described herein relate to an apparatus for wireless communication at a user equipment (UE), including: one or more memories; and one or more processors coupled to the one or more memories and configured to cause the UE to: receive an indication of multiple discontinuous transmission (DTX) configurations for a cell; receive an activation indication for a first DTX configuration from the multiple DTX configurations for the cell; and skip monitoring for a physical downlink control channel (PDCCH) during a non-active period of the first DTX configuration.

In some aspects, the techniques described herein relate to a method of wireless communication at a UE, including: receiving an indication of multiple discontinuous transmission (DTX) configurations for a cell; receiving an activation indication for a first DTX configuration from the multiple DTX configurations for the cell; and skipping monitoring for a physical downlink control channel (PDCCH) during a non-active period of the first DTX configuration.

In some aspects, the techniques described herein relate to an apparatus for wireless communication at a UE, including: means for receiving an indication of multiple discontinuous transmission (DTX) configurations for a cell; means for receiving an activation indication for a first DTX configuration from the multiple DTX configurations for the cell; and means for skipping monitoring for a physical downlink control channel (PDCCH) during a non-active period of the first DTX configuration.

In an aspect of the disclosure, a computer-readable storage medium is provided. The computer-readable medium stores computer executable code at a UE, the code when executed by one or more processors causes the UE to: receive an indication of multiple discontinuous transmission (DTX) configurations for a cell; receive an activation indication for a first DTX configuration from the multiple DTX configurations for the cell; and skip monitoring for a physical downlink control channel (PDCCH) during a non-active period of the first DTX configuration.

In some aspects, at least one DTX configuration in the multiple DTX configurations may include a configuration for non-active periods and/or active periods associated with a power spectral density level.

In an aspect of the disclosure, a computer-readable medium is provided. The computer-readable medium stores computer executable code at a UE, the code when executed by one or more processors causes the UE to: receive an indication of multiple discontinuous transmission (DTX) configurations for a cell; receive an deactivation indication for a first DTX configuration and an activation indication of a second DTX configuration; and skip monitoring for a physical downlink control channel (PDCCH) during a non-active period of the second DTX configuration.

In some aspects, the techniques described herein relate to an apparatus for wireless communication at a network node, including: one or more memories; and one or more processors coupled to the one or more memories and configured to cause the network node to: provide an indication of multiple discontinuous transmission (DTX) configurations for a cell; provide an activation indication for a first DTX configuration from the multiple DTX configurations for the cell; and skip transmission of a physical downlink control channel (PDCCH) to a group of or all user equipments (UE's) during a non-active period of the first DTX configuration.

In some aspects, the techniques described herein relate to a method of wireless communication at a network node, including: providing an indication of multiple discontinuous transmission (DTX) configurations for a cell; providing an activation indication for a first DTX configuration from the multiple DTX configurations for the cell; and skipping transmission of a physical downlink control channel (PDCCH) to a user equipment (UE) during a non-active period of the first DTX configuration.

In some aspects, the techniques described herein relate to an apparatus for wireless communication at a network node, including: means for providing an indication of multiple discontinuous transmission (DTX) configurations for a cell; means for providing an activation indication for a first DTX configuration from the multiple DTX configurations for the cell; and means for skipping transmission of a physical downlink control channel (PDCCH) to a user equipment (UE) during a non-active period of the first DTX configuration.

In an aspect of the disclosure, a computer-readable storage medium is provided. The computer-readable medium stores computer executable code at a network node, the code when executed by one or more processors causes the network node to: provide an indication of multiple discontinuous transmission (DTX) configurations for a cell; provide an activation indication for a first DTX configuration from the multiple DTX configurations for the cell; and skip transmission of a physical downlink control channel (PDCCH) to a user equipment (UE) during a non-active period of the first DTX configuration.

In some aspects, at least one DTX configuration in the multiple DTX configurations may include a configuration for non-active periods and/or active periods associated with a power spectral density level.

In an aspect of the disclosure, a computer-readable storage medium is provided. The computer-readable storage medium stores computer executable code at a network node, the code when executed by one or more processors causes the network node to: provide an indication of multiple discontinuous transmission (DTX) configurations for a cell; provide an deactivation indication for a first DTX configuration and an indication of a second DTX configuration; and skip transmission of a physical downlink control channel (PDCCH) during a non-active period of the first DTX configuration.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network (NW), in accordance with various aspects of the present disclosure.

FIG. 2 shows a diagram illustrating architecture of an example of a disaggregated base station, in accordance with various aspects of the present disclosure.

FIG. 3A is a diagram illustrating an example of a first subframe within a frame structure, in accordance with various aspects of the present disclosure.

FIG. 3B is a diagram illustrating an example of downlink (DL) channels within a subframe, in accordance with various aspects of the present disclosure.

FIG. 3C is a diagram illustrating an example of a second subframe within a frame structure, in accordance with various aspects of the present disclosure.

FIG. 3D is a diagram illustrating an example of uplink (UL) channels within a subframe, in accordance with various aspects of the present disclosure.

FIG. 4 is a block diagram illustrating an example of a network node in communication with a UE in an access network, in accordance with various aspects of the present disclosure.

FIG. 5 is a diagram illustrating an example environment that may support wireless communication including aspects of a terrestrial network and a non-terrestrial network, as presented herein.

FIG. 6A is a diagram 650 that illustrates an example NTN node that can transmit using multiple beams.

FIG. 6B illustrates an example of a transmit pattern for a single satellite beam showing the use of different power spectral density (PSD) for transmissions on the beam at different times.

FIG. 7A, FIG. 7B, FIG. 7C, and FIG. 7D illustrate an example DTX patterns.

FIG. 8 illustrates an example call flow diagram illustrating an example of a UE in wireless communication with a network node such as a base station.

FIG. 9 illustrates an example time diagram showing an application time following a signal indicating an activation of a cell DTX pattern.

FIG. 10 is a flowchart of a method of wireless communication.

FIG. 11 is a flowchart of a method of wireless communication.

FIG. 12 is a diagram illustrating an example of a hardware implementation for an example apparatus and/or UE.

FIG. 13 is a diagram illustrating an example of a hardware implementation for an example network entity.

### DETAILED DESCRIPTION

A cell discontinuous transmission (DTX) configuration may be configured for a cell (e.g., a serving cell) and indicated to UEs served by the cell. A cell DTX configuration indicates a repeating pattern of active periods and non-active periods for the cell. During each non-active period, a UE may reduce monitoring for downlink signals from a base station. In some aspects, based on a cell DTX configuration, a UE may skip monitoring for some PDCCH transmissions, yet may continue to monitor for PDCCH in a common search space (CSS). A CSS is a search space that multiple UEs (e.g., each UE served by the cell) monitor for signaling that applies to UEs in the cell. In order to maintain accurate reception and/or transmission of wireless communication, a UE may measure characteristics of a radio channel, for example by performing channel measurements on a reference signal such as performing CSI-RS measurements. Such CSI-RS measurement may be used for various purposes, e.g., for determinations about modulation, code rate, beam forming determinations, mobility, frequency and time tracking, among other examples. During a cell DTX non-active period, the UE may skip reception of some CSI-RS, yet may continue to receive and measure other CSI-RS. As an example, a UE may monitor for and receive a tracking reference signal (TRS) while skipping reception of configured reference signals. In some aspects, a UE may receive an indication of a single cell DTX configuration (e.g., a single configuration for cell DTX), which may be activated or deactivated. It can take time for a network node o signal a cell DTX configuration to the UE. As the network signals a single cell DTX configuration to the UE, the added time for a new cell DTX configuration to be signaled to the UE causes a before the new cell DTX configuration can be activated for the UE. Aspects of the method presented herein improve the configuration and activation/deactivation of cell DTX configurations, and enable a network to more dynamically adjust a cell DTX pattern. As described herein a cell DTX pattern may also be referred to as a cell DTX configuration. In order to more quickly change a cell DTX pattern, the network may initially indicate multiple cell DTX patterns/cell DTX configurations. By providing an indication of multiple cell DTX configurations/cell DTX patterns, the network may more quickly activate and deactivate different cell DTX configurations for the cell in comparison to the configuration of a single DTX pattern/cell DTX configuration. For example, the network may change to a different DTX pattern or cell DTX configuration by activating one of the previously indicated patterns/configurations without waiting to transmit the different DTX pattern/cell DTX configuration.

In addition to the behavior in which a UE monitors PDCCH in a CSS and/or monitors for configured downlink signals (CSI-RS) during a cell DTX non-active period, aspects presented herein further provide for a UE to skip monitoring for PDCCH in each search space, including a CSS, and/or to skip monitoring for configured downlink signals (e.g., including CSI-RS) during a non-active period of a cell DTX configuration. In some aspects, the different cell DTX operation may be referred to as different “types” of cell DTX. For example, the cell DTX operation that includes the UE skipping monitoring some PDCCH while continuing to monitor PDCCH in CSSs and/or continuing to monitor configured downlink signals (e.g., CSI-RS) in non-active periods may be referred to as a first type of cell DTX. The cell DTX operation in which the UE further skips monitoring PDCCH in the CSSs and/or further skips monitoring for configured downlink signals (e.g., CSI-RS) in the non-active periods may be referred to as a second type of cell DTX. Aspects provide for a UE to receive an indication of multiple DTX configurations for a cell and to receive an activation of one of the previously indicated DTX configurations (e.g., a first cell DTX configuration) for the cell. Each cell DTX configuration indicates a pattern of active periods and non-active periods for the cell. The network may deactivate the first cell DTX configuration and/or activate a different cell DTX configuration (e.g., a second cell DTX configuration) from the indicated set of multiple cell DTX configurations.

A network node, such as a base station or one or more components of a base station, may support multiple cells. The cell DTX configuration for a first cell may enable the network node to increase a power spectral density (PSD) (e.g., a measure of a signal's power content as a function of the frequency of the signal) for a transmission on a beam used for a second cell, e.g., during a non-active period for the first cell. In some aspects, a power spectral density may be associated with a cell DTX configuration, or with an active period of a cell DTX configuration. The DTX configuration for the cell enables a network node, such as a base station, to increase power spectral density (PSD) of a transmission through power sharing among beams, e.g., such as during a non-active period of the DTX configuration for the cell. In some aspects, the DTX configuration may include a first period associated with a first PSD level and a second period associated with a second PSD level. The flexibility in the DTX pattern for a cell enables more flexibility to the network in using power sharing among beams. For example, aspects provided herein enable cell DTX operation in which the UE further skips monitoring PDCCH in the CSSs and/or further skips monitoring for configured downlink signals (e.g., CSI-RS) in the non-active periods may be referred to as a second type of cell DTX. By allowing CSI-RS transmissions to be skipped, the power may be used in connection with another beam. The increased flexibility can be helpful for non-terrestrial network (NTN) nodes, for example, which may support a large number of cells through a large number of beams. The aspects presented herein enable the NTN node to more efficiently perform power sharing among beams through improved configuration and activation of DTX configurations for cells. The improved power sharing may be used to increase power spectral density of transmissions, which may improve reception of such transmissions and the system throughput.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in any combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

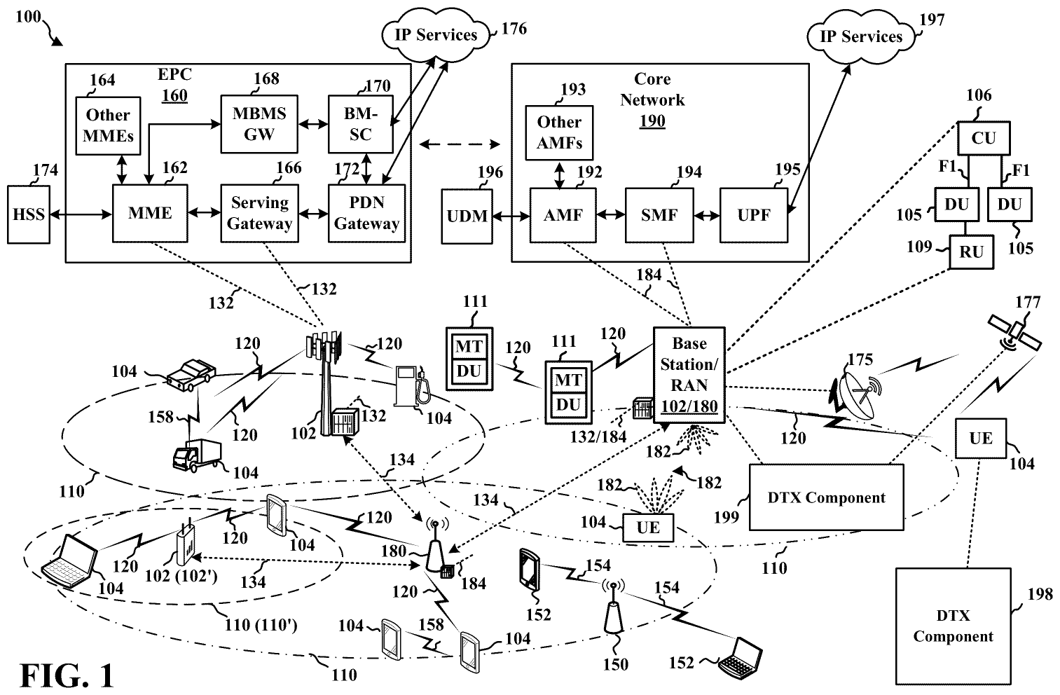

FIG. 1 is a diagram illustrating an example of a wireless communications system and an access network 100. The wireless communications system (also referred to as a wireless wide area network (WWAN)) includes base stations 102, UEs 104, an Evolved Packet Core (e.g., an EPC 160), and another core network 190 (e.g., a 5G Core (5GC)). The base stations 102 may include macrocells (high power cellular base station) and/or small cells (low power cellular base station). The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station (e.g., one of the base stations 102 or one of base stations 180) may be referred to as a RAN and may include aggregated or disaggregated components. As an example of a disaggregated RAN, a base station may include a central unit (CU) (e.g., a CU 106), one or more distributed units (DU) (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

The base stations 102 may wirelessly communicate with the UEs 104. Each of the base stations 102 may provide communication coverage for a respective geographic coverage area 110. There may be overlapping geographic coverage areas. For example, a small cell may have a coverage area 111 that overlaps the respective geographic coverage area 110 of one or more base stations (e.g., one or more macro base stations, such as the base stations 102). A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE to a base station and/or downlink (DL) (also referred to as forward link) transmissions from a base station to a UE. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication links, such as a D2D communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE), Wi-Fi based on the IEEE 802.11 standard, LTE, or NR.

The wireless communications system may further include a Wi-Fi access point (AP), such as an AP 150, in communication with Wi-Fi stations (STAs), such as STAs 152, via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell may operate in a licensed and/or an unlicensed frequency spectrum. When operating in an unlicensed frequency spectrum, the small cell may employ NR and use the same unlicensed frequency spectrum (e.g., 5 GHZ, or the like) as used by the AP 150. The small cell, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station, whether a small cell or a large cell (e.g., a macro base station), may include and/or be referred to as an eNB, gNodeB (gNB), or another type of base station. Some base stations, such as a gNB, may operate in a traditional sub 6 GHZ spectrum, in millimeter wave frequencies, and/or near millimeter wave frequencies in communication with the UEs 104. When the gNB operates in millimeter wave or near millimeter wave frequencies, the base stations 180 may be referred to as a millimeter wave base station. A millimeter wave base station may utilize beamforming 182 with the UEs 104 to compensate for the path loss and short range. The base stations 180 and the UEs 104 may each include a plurality of antennas, such as antenna elements, antenna panels, and/or antenna arrays to facilitate the beamforming.

The base stations 180 may transmit a beamformed signal to the UEs 104 in one or more transmit directions. The UEs 104 may receive the beamformed signal from the base stations 180 in one or more receive directions. The UEs 104 may also transmit a beamformed signal to the base stations 180 in one or more transmit directions. The base stations 180 may receive the beamformed signal from the UEs 104 in one or more receive directions. The base stations 180/UEs 104 may perform beam training to determine the best receive and transmit directions for each of the base stations 180/UEs 104. The transmit and receive directions for the base stations 180 may or may not be the same. The transmit and receive directions for the UEs 104 may or may not be the same.

The EPC 160 may include a Mobility Management Entity (e.g., an MME 162), other MMEs 164, a Serving Gateway 166, a Multimedia Broadcast Multicast Service (MBMS) Gateway (e.g., a MBMS Gateway 168), a Broadcast Multicast Service Center (BM-SC) (e.g., a BM-SC 170), and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) 194, and a User Plane Function (UPF) (e.g., a UPF 195). The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base stations 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base stations 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN). The base stations 102 provide an access point to the EPC 160 or core network 190 for the UEs 104.

A non-terrestrial network (NTN) may refer to a wireless communication system that utilizes satellite nodes 177 (which may be referred to as NTN nodes), in order to provide wireless communication services to UEs. In an example, a UE may transmit first data and/or first signal(s) to a satellite via a service link and the satellite node may provide or relay the first data and/or the first signal(s) to a terrestrial network node (e.g., a base station) via a feeder link and/or via a gateway 175. The terrestrial network node may transmit second data and/or second signal(s) to the satellite node via the feeder link and the satellite may relay the second data and/or the second signal(s) to the UE via the service link.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UEs may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

In some aspects, the UE 104 may include a DTX component 198 configured to receive an indication of multiple discontinuous transmission (DTX) configurations for a cell; receive an activation indication for a first DTX configuration from the multiple DTX configurations for the cell; and skip monitoring for a physical downlink control channel (PDCCH) during a non-active period of the first DTX configuration.

In some aspects, a network node such as a base station 102 or 180 or a satellite node 177 (e.g., may include a DTX component 199 configured to provide an indication of multiple discontinuous transmission (DTX) configurations for a cell; provide an activation indication for a first DTX configuration from the multiple DTX configurations for the cell; and skip transmission of a physical downlink control channel (PDCCH) to a user equipment (UE) during a non-active period of the first DTX configuration.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

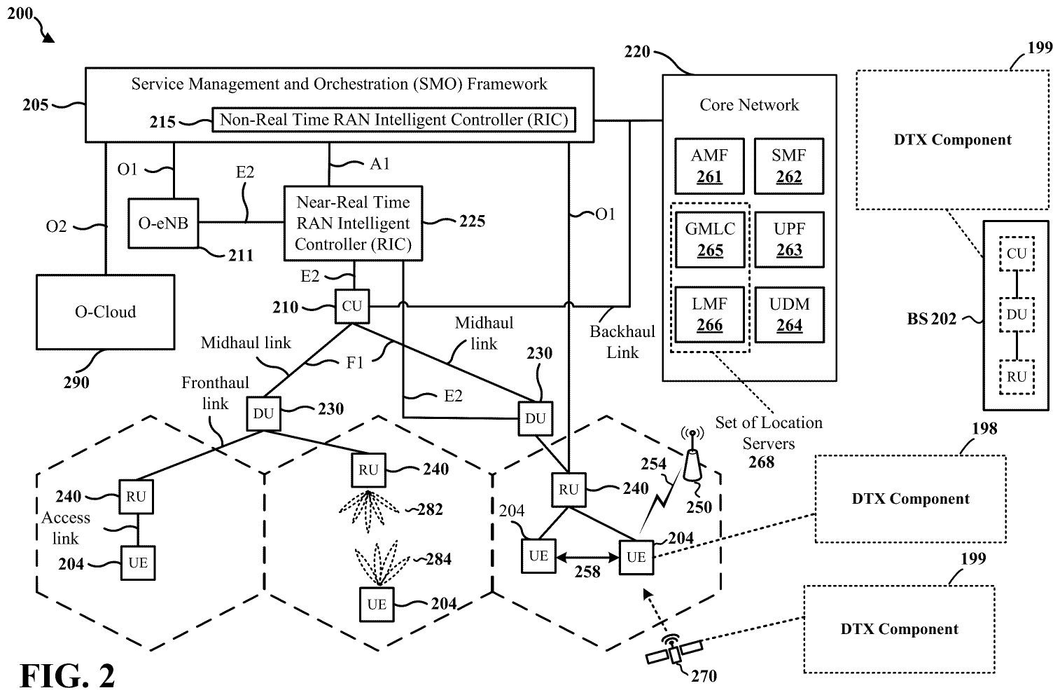

As an example, FIG. 2 shows a diagram illustrating architecture of an example of a disaggregated base station 200. The architecture of the disaggregated base station 200 may include one or more CUs (e.g., a CU 210) that can communicate directly with a core network 220 via a backhaul link, or indirectly with the core network 220 through one or more disaggregated base station units (such as a Near-Real Time (Near-RT) RAN Intelligent Controller (RIC) (e.g., a Near-RT RIC 225) via an E2 link, or a Non-Real Time (Non-RT) RIC (e.g., a Non-RT RIC 215) associated with a Service Management and Orchestration (SMO) Framework (e.g., an SMO Framework 205), or both). A CU 210 may communicate with one or more DUs (e.g., a DU 230) via respective midhaul links, such as an F1 interface. The DU 230 may communicate with one or more RUs (e.g., an RU 240) via respective fronthaul links. The RU 240 may communicate with respective UEs (e.g., a UE 204) via one or more radio frequency (RF) access links. In some implementations, the UE 204 may be simultaneously served by multiple RUS.

Each of the units, i.e., the CUS (e.g., a CU 210), the DUs (e.g., a DU 230), the RUs (e.g., an RU 240), as well as the Near-RT RICs (e.g., the Near-RT RIC 225), the Non-RT RICs (e.g., the Non-RT RIC 215), and the SMO Framework 205, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as an E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 240 can be implemented to handle over the air (OTA) communication with one or more UEs (e.g., the UE 204). In some implementations, real-time and non-real-time aspects of control and user plane communication with the RU 240 can be controlled by a corresponding DU. In some scenarios, this configuration can enable the DU(s) and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements that may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs, DUs, RUS and Near-RT RICs. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

At least one of the CU 210, the DU 230, and the RU 240 may be referred to as a base station 202. Accordingly, a base station 202 may include one or more of the CU 210, the DU 230, and the RU 240 (each component indicated with dotted lines to signify that each component may or may not be included in the base station 202). The base station 202 provides an access point to the core network 220 for a UE 204. The communication links between the RUs (e.g., the RU 240) and the UEs (e.g., the UE 204) may include uplink (UL) (also referred to as reverse link) transmissions from a UE 204 to an RU 240 and/or downlink (DL) (also referred to as forward link) transmissions from an RU 240 to a UE 204.

Certain UEs may communicate with each other using D2D communication (e.g., a D2D communication link 258). The D2D communication link 258 may use the DL/UL WWAN spectrum. The D2D communication link 258 may use one or more sidelink channels. D2D communication may be through a variety of wireless D2D communications systems, such as for example, Bluetooth, Wi-Fi based on the IEEE 802.11 standard, LTE, or NR.

The wireless communications system may further include a Wi-Fi AP 250 in communication with a UE 204 (also referred to as Wi-Fi STAs) via communication link 254, e.g., in a 5 GHz unlicensed frequency spectrum or the like. When communicating in an unlicensed frequency spectrum, the UE 204/Wi-Fi AP 250 may perform a CCA prior to communicating in order to determine whether the channel is available.

The base station 202 and the UE 204 may each include a plurality of antennas, such as antenna elements, antenna panels, and/or antenna arrays to facilitate beamforming. The base station 202 may transmit a beamformed signal 282 to the UE 204 in one or more transmit directions. The UE 204 may receive the beamformed signal from the base station 202 in one or more receive directions. The UE 204 may also transmit a beamformed signal 284 to the base station 202 in one or more transmit directions. The base station 202 may receive the beamformed signal from the UE 204 in one or more receive directions. The base station 202/UE 204 may perform beam training to determine the best receive and transmit directions for each of the base station 202/UE 204. The transmit and receive directions for the base station 202 may or may not be the same. The transmit and receive directions for the UE 204 may or may not be the same.

The core network 220 may include an Access and Mobility Management Function (AMF) (e.g., an AMF 261), a Session Management Function (SMF) (e.g., an SMF 262), a User Plane Function (UPF) (e.g., a UPF 263), a Unified Data Management (UDM) (e.g., a UDM 264), one or more location servers 268, and other functional entities. The AMF 261 is the control node that processes the signaling between the UEs and the core network 220. The AMF 261 supports registration management, connection management, mobility management, and other functions. The SMF 262 supports session management and other functions. The UPF 263 supports packet routing, packet forwarding, and other functions. The UDM 264 supports the generation of authentication and key agreement (AKA) credentials, user identification handling, access authorization, and subscription management. The one or more location servers 268 are illustrated as including a Gateway Mobile Location Center (GMLC) (e.g., a GMLC 265) and a Location Management Function (LMF) (e.g., an LMF 266). However, generally, the one or more location servers 268 may include one or more location/positioning servers, which may include one or more of the GMLC 265, the LMF 266, a position determination entity (PDE), a serving mobile location center (SMLC), a mobile positioning center (MPC), or the like. The GMLC 265 and the LMF 266 support UE location services. The GMLC 265 provides an interface for clients/applications (e.g., emergency services) for accessing UE positioning information. The LMF 266 receives measurements and assistance information from the NG-RAN and the UE 204 via the AMF 261 to compute the position of the UE 204. The NG-RAN may utilize one or more positioning methods in order to determine the position of the UE 204. Positioning the UE 204 may involve signal measurements, a position estimate, and an optional velocity computation based on the measurements. The signal measurements may be made by the UE 204 and/or the base station 202 serving the UE 204. The signals measured may be based on one or more of a satellite positioning system (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Referring again to FIG. 2, in some aspects, the UE 204, similar to the UE 104 in FIG. 1, may have a DTX component 198 configured to receive an indication of multiple discontinuous transmission (DTX) configurations for a cell; receive an activation indication for a first DTX configuration from the multiple DTX configurations for the cell; and skip monitoring for a physical downlink control channel (PDCCH) during a non-active period of the first DTX configuration.

In some aspects, a network node such as a base station 202, or one or more components of the base station 202, or a satellite node 270 may include a DTX component 199 configured to provide an indication of multiple discontinuous transmission (DTX) configurations for a cell; provide an activation indication for a first DTX configuration from the multiple DTX configurations for the cell; and skip transmission of a physical downlink control channel (PDCCH) to a user equipment (UE) during a non-active period of the first DTX configuration.

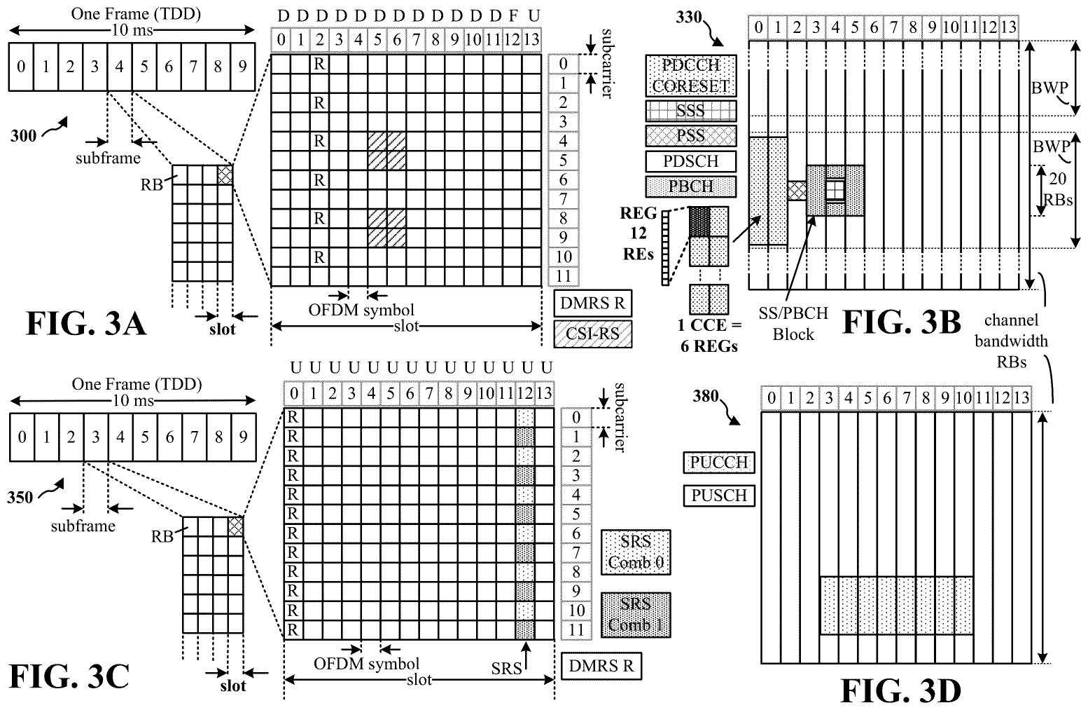

FIG. 3A is a diagram 300 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. As shown in Table 1, the subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The PDCCH carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE, such as one of the UEs 104 of FIG. 1 and/or the UE 204 of FIG. 2, to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The PDSCH carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

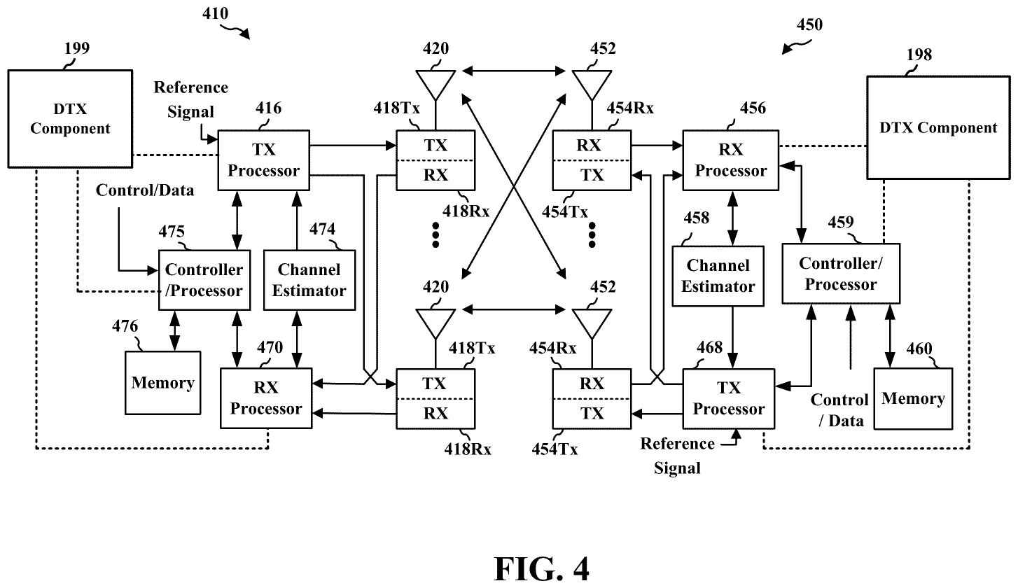

FIG. 4 is a block diagram that illustrates an example of a first wireless device that is configured to exchange wireless communication with a second wireless device. In the illustrated example of FIG. 4, the first wireless device may include a network node such as base station 410, one or more components of a disaggregated base station, or an NTN node such as a satellite based node. The second wireless device may include a UE 450. In an example in which the second wireless device is a base station, the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and at least one memory 476 (e.g., one or more memories). The example UE 450 includes antennas 452, a transmitter 454Tx, a receiver 454Rx, an RX processor 456, a channel estimator 458, a controller/processor 459, at least one memory 460 (e.g., one or more memories), and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the at least one memory 460 that stores program codes and data. The at least one memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the at least one memory 476 that stores program codes and data. The at least one memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the DTX component 198 of FIG. 1.

At least one of the TX processor 416, the RX processor 470, and the controller/processor 475 may be configured to perform aspects in connection with the DTX component 199 of FIG. 1.

A non-terrestrial network (NTN) may refer to a wireless communication system that utilizes satellites in order to provide wireless communication services to UEs. In an example, a UE may transmit first data and/or first signal(s) to a satellite via a service link and the satellite may provide or relay the first data and/or the first signal(s) to a network node (e.g., a base station) via a feeder link. In another example, the network node may transmit second data and/or second signal(s) to the satellite via the feeder link and the satellite may relay the second data and/or the second signal(s) to the UE via the service link.

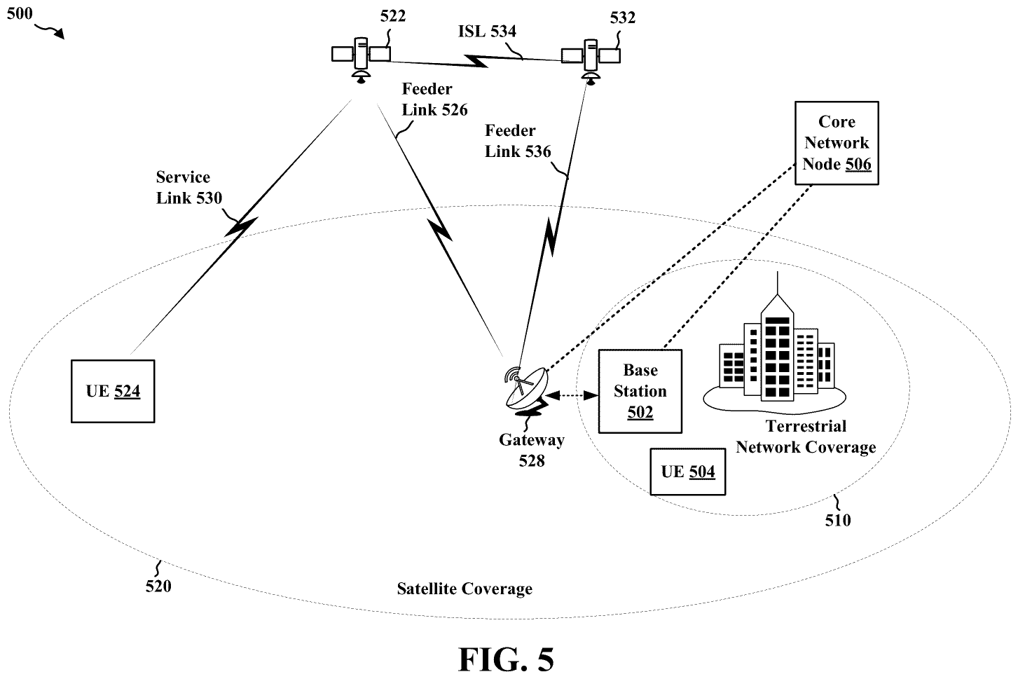

In some examples, a UE may communicate with a terrestrial network. FIG. 5 is a diagram illustrating an example environment 500 that may support wireless communication including aspects of a terrestrial network and a non-terrestrial network, as presented herein. In the illustrated example of FIG. 5, a terrestrial network includes a base station 502 that provides coverage to UEs, such as an example UE 504, located within a coverage area 510 for the terrestrial network. The base station 502 may facilitate communication between the UE 504 and a core network node 506. Aspects of the core network node 506 may be implemented by a core network, such as the example core network 220 of FIG. 2.

In some examples, a UE may transmit or receive satellite-based communication (e.g., via an Iridium-like satellite communication system or a satellite-based 3GPP NTN, among other examples). For example, an NTN node 522, (which may also be referred to as an aerial device, a space vehicle (SV), a network entity, a gNB, a “satellite node”, a satellite NodeB (sNB), “satellite access node”, an NTN base station, etc.) may provide coverage to UEs, such as an example UE 524, located within a coverage area 520 for the NTN node 522. In some examples, the NTN node 522 may communicate with the core network node 506 through a feeder link 526 established between the NTN node 522 and a gateway 528 in order to provide service to the UE 524 within the coverage area 520 of the NTN node 522 via a service link 530. The feeder link 526 may include a wireless link between the NTN node 522 and the gateway 528. The service link 530 may include a wireless link between the NTN node 522 and the UE 524. In some examples, the gateway 528 may communicate directly with the core network node 506. In some examples, the gateway 528 may communicate with the core network node 506 via the base station 502.

In some aspects, the NTN node 522 may be configured to communicate directly with the gateway 528 via the feeder link 526. The feeder link 526 may include a radio link that provides wireless communication between the NTN node 522 and the gateway 528.

In other aspects, the NTN node 522 may communicate with the gateway 528 via one or more other aerial devices. For example, the NTN node 522 and a second NTN node 532 may be part of a constellation of satellites (e.g., aerial devices or NTN nodes) that communicate via inter-satellite links (ISLs). In the example of FIG. 5, the NTN node 522 may establish an ISL 534 with the second NTN node 532. The ISL 534 may be a radio interface or an optical interface and operate in the RF frequency or optical bands, respectively. The second NTN node 532 may communicate with the gateway 528 via a second feeder link 536.

In some examples, the NTN node 522 and/or the second NTN node 532 may include an aerial device, such as an unmanned aircraft system (UAS), a balloon, a drone, an unmanned aerial vehicle (UAV), etc. Examples of a UAS platform that may be used for NTN communication include systems including Tethered UAS (TUA), Lighter Than Air UAS (LTA), Heavier Than Air UAS (HTA), and High Altitude Platforms (HAPs). In some examples, the NTN node 522 and/or the NTN node (e.g., 532) may include a satellite or a space-borne vehicle placed into Low-Earth Orbit (LEO), Medium-Earth Orbit (MEO), Geostationary Earth Orbit (GEO), or High Elliptical Orbit (HEO).

In some aspects, the NTN node 522 and/or the second NTN node 532 may implement a transparent payload. For example, after receiving a signal, a transparent NTN node may have the ability to change the frequency carrier of the signal, perform RF filtering on the signal, and amplify the signal before outputting the signal. In such aspects, the signal output by the transparent NTN node may be a repeated signal in which the waveform of the output signal is unchanged relative to the received signal.

In other aspects, the NTN node 522 and/or the second NTN node 532 may implement a regenerative payload. For example, a regenerative NTN node may have the ability to perform all of or part of the base station functions, such as transforming and amplifying a received signal via on-board processing before outputting a signal. In some such aspects, transformation of the received signal may refer to digital processing that may include demodulation, decoding, switching and/or routing, re-encoding, re-modulation, and/or filtering of the received signal.

In some examples, the NTN node may communicate with the base station 502 via the gateway 528. In some such examples, the base station 502 may facilitate communication between the gateway 528 and the core network node 506. In examples in which the NTN node implements a regenerative payload, the regenerative NTN node may have an on-board base station.

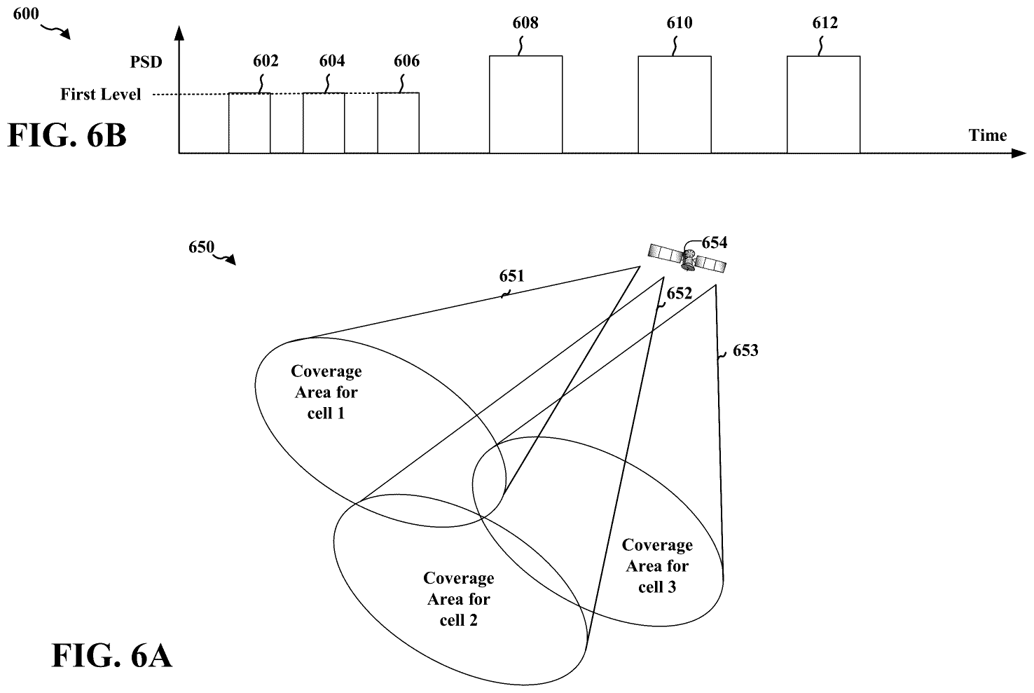

An NTN node, such as a LEO satellite, may support many beams and/or cells. FIG. 6A is a diagram 650 that illustrates an example NTN node 654 that can transmit using multiple beams, e.g., beams 651, 652, and 653, that provide coverage for three cells, e.g., cell 1, cell 2, and cell 3, respectively. Three beams are included in FIG. 6A to illustrate the concept, however, an NTN node 654 may support a much larger number of beams. For example, a LEO satellite may support a few hundred or more than thousands of beams and/or cells. However, only a small portion of the satellite beams may be used to transmit at a particular time. For example, power limitations may limit transmissions of beams from the NTN node. In some aspects, the NTN may use flexible power sharing among the different beams, e.g., when beams are not simultaneously active or are active below a nominal equivalent isotropic radiated power (EIRP) density per satellite beam. FIG. 6B illustrates an example 600 of a transmit pattern for a single satellite beam (e.g., such as beam 651) showing the use of different power spectral density (PSD) for transmissions on the beam at different times. For example, at transmission occasions 602, 604, 606, the transmit PSD for transmissions on the beam does not exceed a first level. At transmission occasions 608, 610, and 612, transmissions on the beam are transmitted with an increased PSD that exceeds the first level. The increased PSD for the transmissions may be based on the absence of transmissions on another beam (e.g., beam 652) during the transmission occasions 608, 610, and 612, or transmissions with a reduced PSD on the other beam. For example, the NTN node may use power sharing among beams so that the power that would have been used for transmissions on the beam 652 can be used together with the power allocated for the beam 651 to transmit with the increased PSD at the transmission occasions 608, 610, and 612. In some aspects, on or more satellite beam may be turned off during some periods of time. As an example, an on/off periodic pattern may be used for transmissions on a beam. The pattern may change over time. The transmit PSD for transmissions on a beam may also be adapted, e.g., may vary or be changed at times.

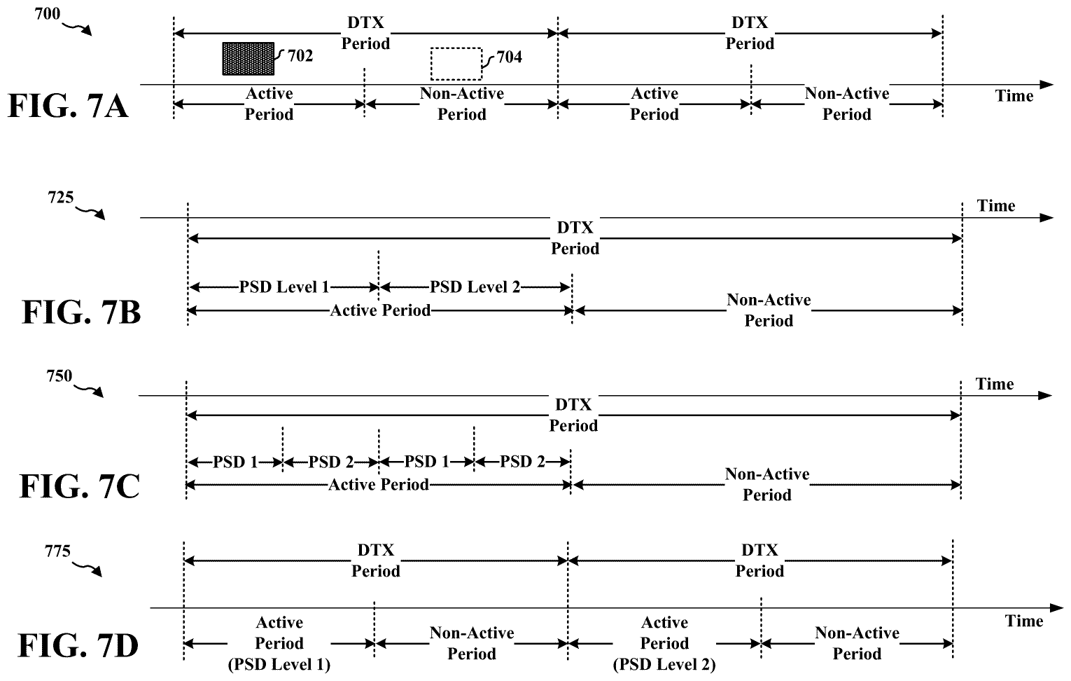

In some aspects, a discontinuous reception (DRX) or discontinuous transmission (DTX) configuration may be configured for a cell. In some aspects, cell DTX may be configured, e.g., if cell DRX is configured. The DTX configuration, for example, may include active periods and non-active periods. FIG. 7A illustrates an example DTX pattern 700 including a repeating (e.g. periodic) pattern of active periods and non-active periods. During a cell DTX non-active period, a UE may skip monitoring for at least some PDCCH. For example, the UE may monitor for PDCCH transmission 702 (e.g., that includes DCI) in an occasion that occurs during the active period of the DTX pattern, and may skip monitoring for the PDCCH transmission 704 in an occasion that occurs during the non-active period of the DTX pattern. In some aspects, a UE configured for operation on a serving cell according to one or both of a cell DTX operation or a cell DRX operation may be provided a common search space (CSS) to monitor PDCCH for detection of DCI. For example, the UE may monitor Type3-PDCCH CSS set to monitor PDCCH for detection of DCI format 2_9 during a non-active period of the DTX pattern. In some aspects, a UE may not expect to monitor PDCCH for detection of DCI (e.g., DCI format 2_9) on more than one serving cell of one cell group. For example, a UE may monitor for a PDCCH transmission (e.g., a PDCCH transmission including DCI) in a CSS and receive the corresponding PDSCH (e.g., indicated by a received DCI) that occurs, at least partially, during a non-active period.

During a non-active period of a cell DTX configuration, the UE may receive CSI-RS other than the periodic CSI-RS and semi-persistent CSI-RS configured in CSI report configuration (e.g., in a “CSI-ReportConfig”) associated with a higher layer parameter associated with a report quantity (e.g., higher layer parameter “reportQuantity”) comprising at least a rank indicator (RI).

Such CSI-RS and TRS may be referred to as a “configured reference signal” or “configured downlink signal,” as the UE receive a configuration for the CSI-RS and TRS. During a non-active period of a cell DTX configuration, the UE may also receive some cell specific signals such as SSB, and some configured downlink signal, such as TRS.

Cell DTX operating in which the UE continues to monitor for at least some PDCCH and/or CSI-RS may be referred to as a type of cell DTX. As the UE continues to monitor for at least some PDCCH and some CSI-RS during the non-active period of the cell DTX pattern, the network node may not be able to use power sharing among beams based on the cell DTX pattern.

Aspects presented herein provide for cell DTX for which a UE does not monitor for PDCCH, including PDCCH in the CSS, during the non-active period (e.g., which may also be referred to as a non-active state or off duration) of the cell DTX pattern. For example, the UE may skip monitoring for PDCCH in any search space, e.g., in all search spaces, during the non-active period of the cell DTX pattern. In some aspects, the UE may also skip reception of configured downlink signals, e.g., including skipping reception of CSI-RS configured for the UE. The UE may continue to receive SSB and/or TRS during the non-active period of the cell DTX pattern. Such cell DTX operation may be referred to as a different type of cell DTX. Various names may be used to refer to the UE action associated with the cell DTX. As an example, cell DTX in which the UE monitors for PDCCH in CSS and/or CSI-RS may be referred to as a first type of cell DTX, and cell DTX in which the UE skips monitoring for PDCCH in CSS and/or skips monitoring for CSI-RS may be referred to as a second type of cell DTX. As another example, cell DTX in which the UE monitors for PDCCH in CSS and/or CSI-RS may be referred to as Type 1 cell DTX, and cell DTX in which the UE skips monitoring for PDCCH in CSS and/or skips monitoring for CSI-RS may be referred to as Type 2 cell DTX. As another example, cell DTX in which the UE monitors for PDCCH in CSS and/or CSI-RS may be referred to as Type A cell DTX, and cell DTX in which the UE skips monitoring for PDCCH in CSS and/or skips monitoring for CSI-RS may be referred to as Type B cell DTX.

In some aspects, a cell DTX configuration may include an indication of a PSD level associated with an active period of the DTX pattern. As an example of PSD levels, a first level may be associated with a value of 0 (e.g., which may correspond to a maximal PSD), and a second level may be associated with a value of −3 (which may correspond to a value of 3 dB below a maximal PSD value). The UE may not expect to receive downlink transmissions with a PSD above a nominal PSD level during the active period of the cell DTX pattern. A remaining amount of PSD (e.g., the difference between a PSD level associated with the first beam and the nominal PSD level) may be used for power sharing with a transmission on a second beam during the active duration of the DTX pattern for the first beam.

In some aspects, a DTX period may include more than two types of durations, e.g., more than an active duration and a non-active duration. As an example, a DTX period may include multiple active durations associated with different PSD levels. FIG. 7B is a time diagram 725 illustrates an example DTX pattern having multiple types of active durations, e.g., including a first portion of the active period that includes a PSD level 1 duration and a second portion that includes PSD level 2 duration. During the PSD level 1 duration, the UE may expect to receive downlink transmissions at a first PSD level (e.g., PSD level 1). During the PSD level 2 duration, the UE may expect to receive downlink transmissions at a second PSD level (e.g., PSD level 2). A remaining amount of power (e.g., due to the difference between a PSD level associated with the first beam and PSD level 1) may be used for power sharing with a transmission on a second beam during the PSD level 1 duration of the DTX pattern for the first beam. A remaining amount of PSD (e.g., the difference between a PSD level associated with the first beam and PSD level 2) may be used for power sharing with a transmission on a second beam during the PSD level 2 duration of the DTX pattern for the first beam. FIG. 7C illustrates a time diagram 750 of an additional example DTX pattern including multiple active periods associated with different PSD levels. FIG. 7D illustrates a time diagram 775 showing an additional example of a cell DTX pattern including multiple types of active periods. Although only two types of active durations are shown to illustrate the concept, the concept may be applied for any number of types of active durations associated with different PSD levels.

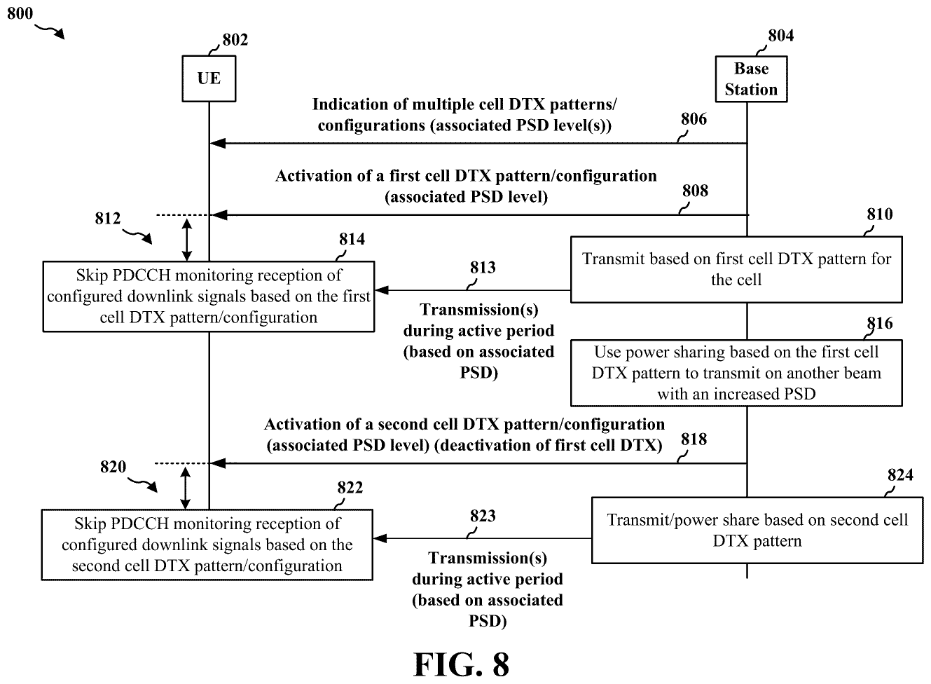

FIG. 8 illustrates an example call flow diagram 800 illustrating an example of a UE 802 in wireless communication with a network node such as a base station 804. Although aspects are described as being performed by the base station 804, various aspects may be performed by the base station in aggregation or by one or more components of a disaggregated base station (e.g., a CU, DU, and/or RU) or by an NTN node.

In some aspects, the UE 802 may receive an indication 806 of multiple DTX configurations for a cell, e.g., rather than a signal cell DTX configuration. The UE 802 may then receive an activation or deactivation of one (or more) of the multiple DTX configurations for the cell.

As an example, a set of cell DTX patterns may be defined, such as defined in a wireless standard, and known by the UE and a network node such as a base station or NTN node. The base station 804 may then indicate a subset of the defined cell DTX patterns (e.g., which may be referred to as cell DTX configurations) to the UE, at 806. The indication may be for a particular cell, for example.

For example, if the DTX patterns are defined, each pattern may be associated with an index, and the UE 802 may receive an indication 806 of a subset of indexes associated with the defined DTX patterns. In some aspects, the DTX patterns may not be defined, and at 806, the UE 802 may receive pattern information for each of the DTX patterns. For example, the UE 802 may receive multiple cell DTX configurations, e.g., with different parameters for the different cell DTX patterns.

In some examples, the UE 802 may receive the indication 806 of the multiple DTX patterns in a broadcast from the network. In some examples, the UE 802 may receive the indication 806 of the multiple DTX patterns in a UE specific message, or a UE specific configuration, that is directed to the UE from the network. In some examples, the UE 802 may receive the indication 806 of the multiple DTX patterns in group common signaling (e.g., that is common to multiple UEs) from the network.

After indicating the multiple cell DTX patterns to the UE 802 (e.g., whether referencing defined cell DTX patterns or providing cell DTX configurations to the UE), the base station 804 may indicate an activation for the cell of one of the previously indicated cell DTX patterns (e.g., a first DTX pattern), at 808. The base station 804 may later indicate a deactivation of the first DTX pattern and an activation of a second DTX pattern from the multiple DTX patterns indicated to the UE, e.g., as shown at 818. In some aspects, the activation of the second cell DTX pattern indicates the deactivation of the first cell DTX pattern. In some aspects, the base station 804 may provide a separate indication of the deactivation of the first cell DTX pattern. The indication of the deactivation of the first cell DTX pattern may be in the same message or same transmission as the activation of the second cell DTX pattern or may be in a different message or different transmission than the activation of the second cell DTX pattern. The ability to signal about a previously indicated cell DTX pattern enables the base station 804 to dynamically activate/deactivate DTX patterns in order to adjust a cell DTX configuration. This reduces the time for the network to change cell DTX configurations and allows the base station to adapt more readily to provide effective and efficient service.

In some aspects, the indication at 808 and/or 808 may include an indication of one or more PSD levels associated with an active period of a DTX configuration, e.g., as described in connection with any of FIGS. 7B-7D.

The base station 804 may indicate the activation/deactivation (e.g., 808 or 818) to the UE, e.g., change the cell DTX pattern, in a broadcast transmission (e.g., via one or more SIBs). This enables the base station 804 to activate/deactivate/change the cell DTX pattern for multiple UEs (e.g., all UEs) served by the cell.

The base station 804 may indicate the activation/deactivation (e.g., 808 or 818) to the UE, e.g., change the cell DTX pattern, in group-common signaling such as a group common PDCCH transmission. This enables the base station 804 to activate/deactivate/change the cell DTX pattern for multiple UEs with a single transmission.

The base station 804 may indicate the activation/deactivation (e.g., 808 or 818) to the UE 802, e.g., change the cell DTX pattern, in UE specific transmission that is directed to the UE, in some aspects.

As illustrated at 814 and 822, the UE applies the indicated cell DTX configuration, e.g., by skipping monitoring PDCCH (e.g., including PDCCH in a CSS) and skipping reception of configured downlink signals (e.g., such as a CSI-RS configured for the UE). The UE may continue to receive SSB and/or TRS for the cell. Similarly, the base station 804 transmits, at 810, based on the indicated DTX pattern. For example, the base station may transmit during the active period, as shown at 813, and may skip PDCCH transmissions and/or CSI-RS transmissions during the non-active period. The base station may also use a PSD according to a PSD level associated with the DTX configuration, e.g., such as described in connection with any of FIGS. 7B-7D). As illustrated at 816, the base station 816 may use power sharing based on the cell DTX of the first cell to transmit at an increased PSD for a different beam (or different cell). Similarly, at 824, the base station 804 may transmit, as shown at 823, and use power sharing, based on the second DTX pattern that was activated at 818.

As an example of multiple cell DTX patterns, 128 cell DTX patterns can be defined or signaled by the network to UE 802, e.g., at 806. The base station 804 may then indicate, at 808, a specific pattern to the UE 802 from the 128 cell DTX patterns to be used in the near future. The number 128 is merely one example of multiple cell DTX patterns, and the number may be any number of 2 or more cell DTX patterns. The concept is not limited to a particular number of cell DTX patterns. As an example, the UE may receive a configuration of 2 cell DTX patterns, 4 cell DTX patterns, or 8 cell DTX patterns, among other examples. For example, the indication of the specific cell DTX pattern, at 808 or 818, may be referred to as an activation of the cell DTX pattern.

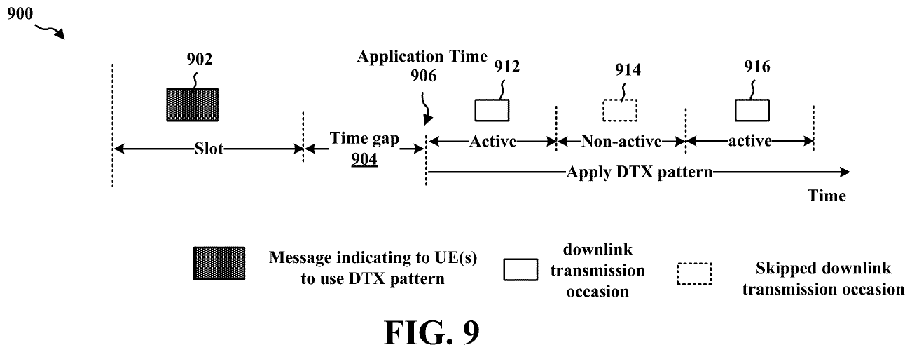

The UE 802 may adjust reception (e.g., skipping monitoring for PDCCH and/or CSI-RS) according to the indicated cell DTX pattern, as shown at 814 and 822, based on an application time, which may include a time gap 812 or 820 after the indication at 808 or 818. FIG. 9 illustrates an example time diagram 900 showing an application time 906 following a signal 902 indicating an activation (or change) of a cell DTX pattern. The application time 906 for the new cell DTX pattern can be included in (e.g., indicated in) the message (e.g., 902) that indicates to use the cell DTX pattern. The application time 906 for the new cell DTX pattern may be based on a time gap 904 (which may be defined) between the transmit timing of the signal 902 indicating to the UE to use the cell DTX pattern and the time at which the UE 802 is expected to apply the indicated cell DTX pattern, e.g., 906. The transmit timing of the signal 902 indicating to the UE to use the cell DTX pattern may be based on a last slot where the signal is carried. In some aspects, the time gap 904 can be a function of an SCS for the cell. FIG. 9 illustrates transmissions occasions 912 and 916, that occur during the active period. The UE may monitor for PDCCH or a configured reference signal at such transmission occasions. At the transmission occasion 914 that occurs during the non-active period of the cell DTX pattern, the UE may skip monitoring for the downlink signal (and the network may similarly skip the transmission).

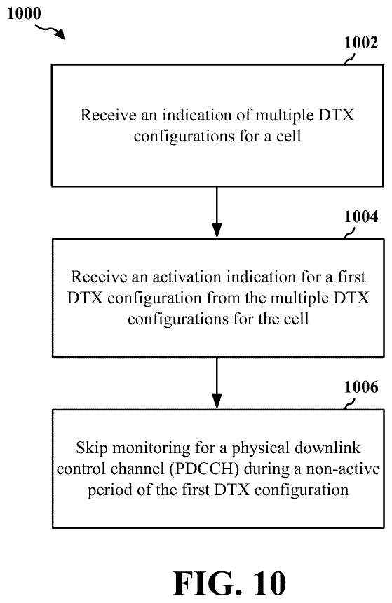

FIG. 10 is a flowchart 1000 of a method of wireless communication. The method may be performed by a UE (e.g., the UE 104, 204, 450, 504, 524, 802; the apparatus 1204). Aspects of the method improve the configuration and activation/deactivation of cell DTX configurations, and enables a network to more dynamically adjust a cell DTX pattern. The flexibility in the DTX pattern for a cell enables more flexibility to the network in using power sharing among beams.

At 1002, the UE receives an indication of multiple discontinuous transmission (DTX) configurations for a cell. FIG. 8 illustrates an example of a UE 802 receiving an indication 806. The indication of the multiple DTX configurations may be in a broadcast message. The indication of the multiple DTX configurations may be in at least one UE specific message. The indication of the multiple DTX configurations may be in group common signaling message that is common to multiple UEs. The indication may indicate the multiple DTX configurations from a set of defined DTX configurations. A DTX configuration in the multiple DTX configurations may include a configuration for non-active periods, a first active period associated with a first power spectral density level, and a second active period associated with a second power spectral density level. At least one DTX configuration in the multiple DTX configurations may include a configuration for non-active periods and active periods associated with a power spectral density level. FIGS. 7A-7D illustrate example aspects of DTX configurations. The reception may be performed, e.g., by the DTX component 198 of the apparatus 1204, in some aspects.

At 1004, the UE receives an activation indication for a first DTX configuration from the multiple DTX configurations for the cell. FIG. 8 illustrates an example of a UE 802 receiving an indication 808 that activates a DTX pattern/configuration from the multiple DTX patterns/configurations previously indicated to the UE. The activation indication may be in at least one of a broadcast message, a UE specific message, or group common signaling that is common to multiple UEs. The reception may be performed, e.g., by the DTX component 198 of the apparatus 1204, in some aspects.

At 1006, the UE skips monitoring for a physical downlink control channel (PDCCH) during (e.g., in) a non-active period of the first DTX configuration. An application time for the first DTX configuration may be based on a defined time gap relative to the indication or an indicated time gap. The application time may be a function of a subcarrier spacing (SCS). FIGS. 8 and 9 illustrate example aspects of an application for the DTX configuration. Skipping monitoring the PDCCH may include skipping monitoring the PDCCH in all search spaces during (e.g., in) the non-active period of the first DTX configuration. In some aspects, the UE may further skip reception of configured reference signals during the non-active period of the first DTX configuration for the cell. In some aspects, skipping the reception of the configured reference signals may include skipping the reception of a channel state information reference signal (CSI-RS) during the non-active period. In some aspects, the UE may monitor for at least one of a synchronization signal block (SSB) or a tracking reference signal (TRS) during the non-active period. The skipping of the monitoring may be performed, e.g., by the DTX component 198 of the apparatus 1204, in some aspects.

In some aspects, the UE may receive an deactivation indication for the first DTX configuration and an activation indication of a second DTX configuration. The UE may then skip monitoring for the PDCCH during a non-active period of the second DTX configuration.

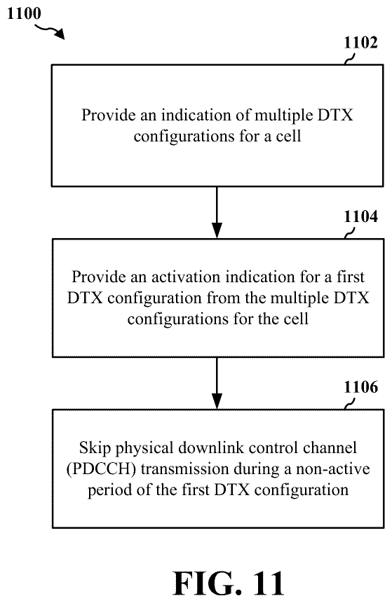

FIG. 11 is a flowchart 1100 of a method of wireless communication. The method may be performed by a network node. In some aspects, the network node may be a base station in aggregation or one or more components of a disaggregated base station (e.g., the base station 102, 202, 410, 804; the NTN node 522, 532, 654; the CU 106, 210; the DU 105, 230; the RU 109, 240; the network entity 1302). Aspects of the method improve the configuration and activation/deactivation of cell DTX configurations, and enables a network to more dynamically adjust a cell DTX pattern. The flexibility in the DTX pattern for a cell enables more flexibility to the network in using power sharing among beams.

At 1102, the network node provides (e.g., transmits or outputs) an indication of multiple discontinuous transmission (DTX) configurations for a cell. FIG. 8 illustrates an example of a base station 804, as an example of a network node, providing an indication 806. The indication of the multiple DTX configurations may be in a broadcast message. The indication of the multiple DTX configurations may be in at least one UE specific message. The indication of the multiple DTX configurations may be in group common signaling that is common to multiple UEs. The indication may indicate the multiple DTX configurations from a set of defined DTX configurations. A DTX configuration in the multiple DTX configurations may include a configuration for non-active periods, a first active period associated with a first power spectral density level, and a second active period associated with a second power spectral density level. At least one DTX configuration in the multiple DTX configurations may include a configuration for non-active periods and active periods associated with a power spectral density level. FIGS. 7A-7D illustrate example aspects of DTX configurations. The providing may be performed, e.g., by the DTX component 199 of the network entity 1302, in some aspects.

At 1104, the network node provides (e.g., transmits or outputs) an activation indication for a first DTX configuration from the multiple DTX configurations for the cell. FIG. 8 illustrates an example of a base station 804, as an example of a network node, providing an indication 808 that activates a DTX pattern/configuration from the multiple DTX patterns/configurations previously indicated to the UE. The activation indication may be in at least one of a broadcast message, a UE specific message, or group common signaling that is common to multiple UEs. The providing may be performed, e.g., by the DTX component 199 of the network entity 1302, in some aspects.

At 1106, the network node skips transmission of a physical downlink control channel (PDCCH) (e.g., to a group of all UEs) during (e.g., in) a non-active period of the first DTX configuration. An application time for the first DTX configuration may be based on a defined time gap relative to the indication or an indicated time gap. The application time may be a function of a subcarrier spacing (SCS). FIGS. 8 and 9 illustrate example aspects of an application for the DTX configuration. Skipping transmission of the PDCCH may include skipping transmission of the PDCCH in all search spaces during the non-active period of the first DTX configuration. In some aspects, the network node may further skip transmission of configured reference signals during the non-active period of the first DTX configuration for the cell. In some aspects, skipping the transmission of the configured reference signals may include skipping the transmission of a channel state information reference signal (CSI-RS) during the non-active period. In some aspects, the network node may provide, e.g., transmit, at least one of a synchronization signal block (SSB) or a tracking reference signal (TRS) during the non-active period. The skipping of the transmission may be performed, e.g., by the DTX component 199 of the network entity 1302, in some aspects.

In some aspects, the cell is a first cell associated with a first beam, and the network node may transmit communication on a second beam associated with a second cell using power sharing based the non-active period of the DTX configuration for the first cell. Example aspects of power sharing are described in connection with FIG. 6B.

In some aspects, the network node may provide a deactivation indication for the first DTX configuration and an activation indication of a second DTX configuration from the multiple DTX configurations. The network node may then skip transmission of the PDCCH during a non-active period of the second DTX configuration.

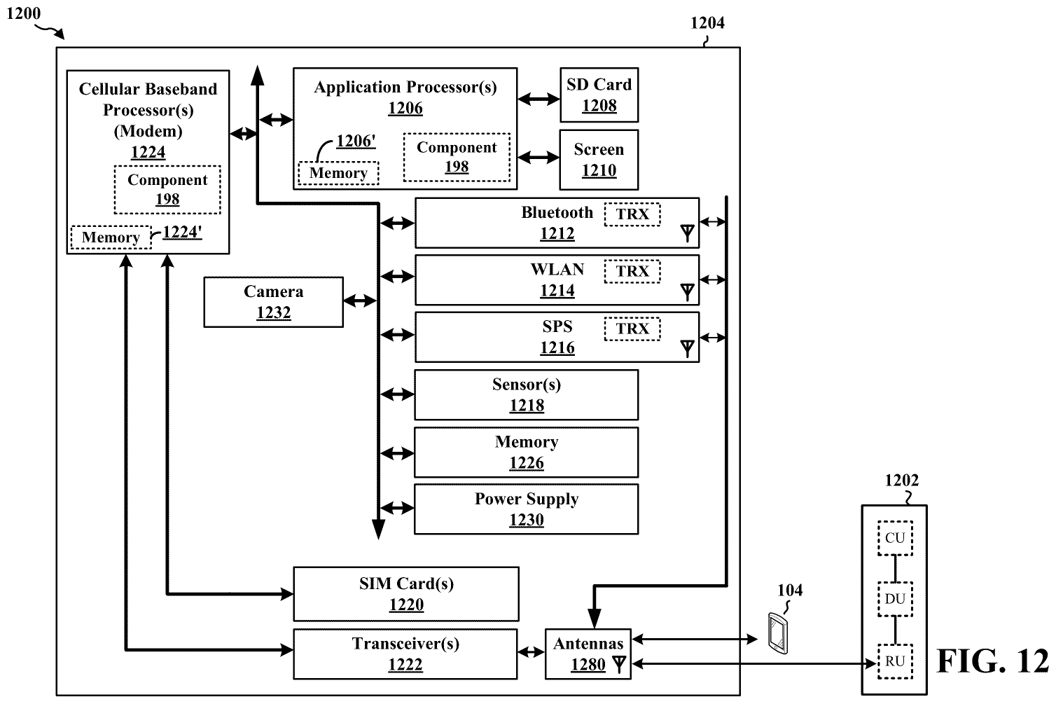

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The cellular baseband processor(s) 1224 and the application processor(s) 1206 are configured to perform the various functions described supra based at least in part of the information stored in the memory. That is, the cellular baseband processor(s) 1224 and the application processor(s) 1206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 450 and may include the at least one memory 460 and/or at least one of the TX processor 468, the RX processor 456, and the controller/processor 459. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 450 of FIG. 4) and include the additional modules of the apparatus 1204.

As discussed supra, the component 198 may be configured to receive an indication of multiple discontinuous transmission (DTX) configurations for a cell; receive an activation indication for a first DTX configuration from the multiple DTX configurations for the cell; and skip monitoring for a physical downlink control channel (PDCCH) during a non-active period of the first DTX configuration. The apparatus 1204 may be further configured to skip reception of configured reference signals during the non-active period of the first DTX configuration for the cell. The apparatus 1204 may be configured to monitor for at least one of a synchronization signal block (SSB) or a tracking reference signal (TRS) during the non-active period. The apparatus 1204 may be further configured to perform any of the aspects performed by the UE in FIG. 9 and/or in the flowchart in FIG. 10. The component 198 may be within the cellular baseband processor(s) 1224, the application processor(s) 1206, or both the cellular baseband processor(s) 1224 and the application processor(s) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for receiving an indication of multiple discontinuous transmission (DTX) configurations for a cell; means for receiving an activation indication for a first DTX configuration from the multiple DTX configurations for the cell; and means for skipping monitoring for a physical downlink control channel (PDCCH) during a non-active period of the first DTX configuration. The apparatus 1204 may further include means for skipping reception of configured reference signals during the non-active period of the first DTX configuration for the cell. The apparatus 1204 may further include means for monitoring for at least one of a synchronization signal block (SSB) or a tracking reference signal (TRS) during the non-active period. The apparatus 1204 may further include means for performing any of the aspects performed by the UE in FIG. 9 and/or in the flowchart in FIG. 10. The means may be the component 198 of the apparatus 1204 configured to perform the functions recited by the means. As described supra, the apparatus 1204 may include the TX processor 468, the RX processor 456, and the controller/processor 459. As such, in one configuration, the means may be the TX processor 468, the RX processor 456, and/or the controller/processor 459 configured to perform the functions recited by the means.

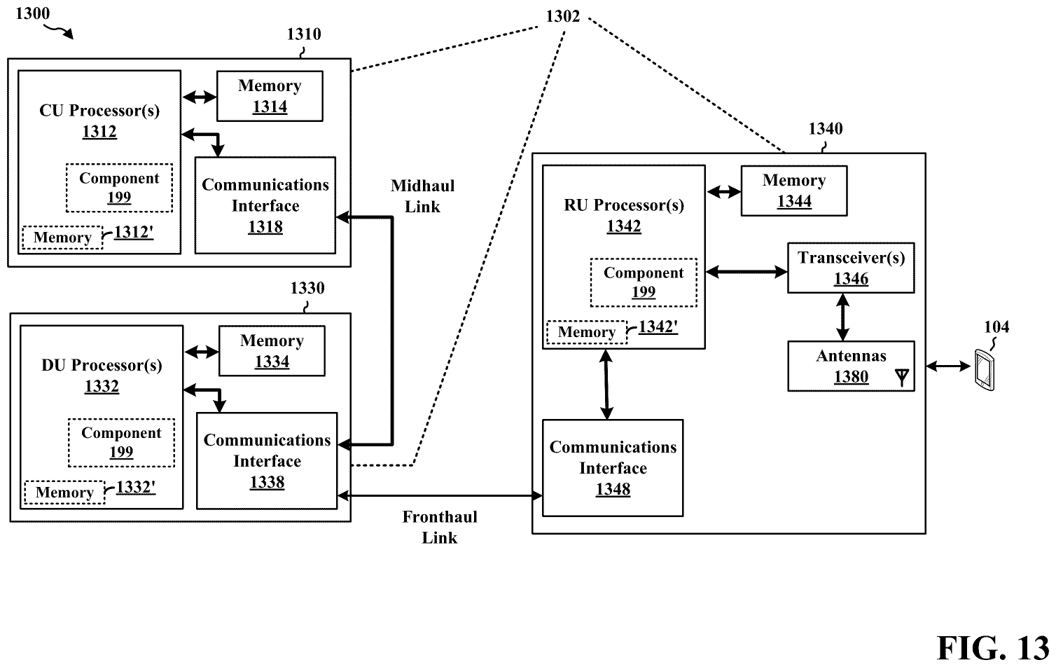

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. In some aspects, the network entity may be an NTN node, e.g., as described in connection with FIG. 5 and FIG. 6A. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide an indication of multiple discontinuous transmission (DTX) configurations for a cell; provide an activation indication for a first DTX configuration from the multiple DTX configurations for the cell; and skip transmission of a physical downlink control channel (PDCCH) to a user equipment (UE) during a non-active period of the first DTX configuration. The network entity 1302 may be further configured to skip providing configured reference signals in the cell during the non-active period of the first DTX configuration for the cell. The network entity 1302 may be further configured to provide at least one of a synchronization signal block (SSB) or a tracking reference signal (TRS) of the cell during the non-active period. The network entity 1302 may be further configured to transmit communication on a second beam associated with a second cell using power sharing based the non-active period of the DTX configuration for the first cell. The DTX component 199 and/or the network entity 1302 may be configured to perform any of the aspects described in connection with the flowchart in FIG. 11 and/or performed by the base station in the communication flow in FIG. 9. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for providing an indication of multiple discontinuous transmission (DTX) configurations for a cell; means for providing an activation indication for a first DTX configuration from the multiple DTX configurations for the cell; and means for skipping transmission of a physical downlink control channel (PDCCH) to a user equipment (UE) during a non-active period of the first DTX configuration. The network entity 1302 may further include means for skipping providing configured reference signals in the cell during the non-active period of the first DTX configuration for the cell. The network entity 1302 may further include means for providing at least one of a synchronization signal block (SSB) or a tracking reference signal (TRS) of the cell during the non-active period. The network entity 1302 may further include means for transmitting communication on a second beam associated with a second cell using power sharing based the non-active period of the DTX configuration for the first cell. The network entity may further include means for performing any of the aspects described in connection with the flowchart in FIG. 11 and/or performed by the base station in the communication flow in FIG. 9. The means may be the component 199 of the network entity 1302 configured to perform the functions recited by the means. As described supra, the network entity 1302 may include the TX processor 416, the RX processor 470, and the controller/processor 475. As such, in one configuration, the means may be the TX processor 416, the RX processor 470, and/or the controller/processor 475 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. When at least one processor (i.e., a one or more processors or a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is a method of wireless communication at a user equipment (UE), comprising: receiving an indication of multiple discontinuous transmission (DTX) configurations for a cell; receiving an activation indication for a first DTX configuration from the multiple DTX configurations for the cell; and skipping monitoring for a physical downlink control channel (PDCCH) during a non-active period of the first DTX configuration.

In aspect 2, the method of aspect 1 further includes that the indication of the multiple DTX configurations is in a broadcast message.

In aspect 3, the method of aspect 1 further includes that the indication of the multiple DTX configurations is in at least one UE specific message.

In aspect 4, the method of aspect 1 further includes that the indication of the multiple DTX configurations is in group common signaling that is common to multiple UEs.

In aspect 5, the method of any of aspects 1-4 further includes that the indication indicates the multiple DTX configurations from a set of defined DTX configurations.

In aspect 6, the method of any of aspects 1-5 further includes that the activation indication is in at least one of a broadcast message, a UE specific message, or group common signaling that is common to multiple UEs.

In aspect 7, the method of any of aspects 1-6 further includes that the activation indication also indicates the deactivation of a currently activated DTX configuration for the cell.

In aspect 8, the method of any of aspects 1-7 further includes that a DTX configuration in the multiple DTX configurations includes a configuration for non-active periods, a first active period associated with a first power spectral density level, and a second active period associated with a second power spectral density level.

In aspect 9, the method of any of aspects 1-8 further includes that at least one DTX configuration in the multiple DTX configurations includes a configuration for non-active periods and active periods associated with a power spectral density level.

In aspect 10, the method of any of aspects 1-9 further includes that an application time for the first DTX configuration is based on a defined time gap relative to the indication or an indicated time gap.

In aspect 11, the method of aspect 10 further includes that the application time is a function of a subcarrier spacing (SCS).

In aspect 12, the method of any of aspects 1-11 further includes that skipping monitoring the PDCCH includes skipping monitoring the PDCCH in all search spaces during the non-active period of the first DTX configuration.

In aspect 13, the method of any of aspects 1-12, further comprises skipping reception of configured reference signals during the non-active period of the first DTX configuration for the cell.

In aspect 14, the method of aspect 13 further includes that the configured reference signals includes a channel state information reference signal (CSI-RS) during the non-active period.

In aspect 15, the method of aspect 14, further comprises: monitoring for at least one of a synchronization signal block (SSB) or a tracking reference signal (TRS) during the non-active period.

In aspect 16, the method of any of aspects 1-15, wherein the activation indication of the first DTX configuration is a first activation indication, and the method further includes receiving an deactivation indication for the first DTX configuration and a second activation indication of a second DTX configuration; and skipping monitoring for the PDCCH during one or more non-active periods of the second DTX configuration.

Aspect 17 is a method for wireless communication at a network node, comprising: providing an indication of multiple discontinuous transmission (DTX) configurations for a cell; providing an activation indication for a first DTX configuration from the multiple DTX configurations for the cell; and skipping transmission of a physical downlink control channel (PDCCH) to a group of all user equipment (UEs) during a non-active period of the first DTX configuration.

In aspect 18, the method of aspect 17 further includes that the indication of the multiple DTX configurations is in a broadcast.

In aspect 19, the method of aspect 17 further includes that the indication of the multiple DTX configurations is in at least one UE specific message.

In aspect 20, the method of aspect 17 further includes that the indication of the multiple DTX configurations is in group common signaling that is common to multiple UEs.

In aspect 21, the method of any of aspects 17-20 further includes that the indication indicates the multiple DTX configurations from a set of defined DTX configurations.

In aspect 22, the method of any of aspects 17-21 further includes that the activation indication is in at least one of a broadcast, a UE specific message, or group common signaling that is common to multiple UEs.

In aspect 23, the method of any of aspects 17-22 further includes that the activation indication also indicates the deactivation of a currently activated DTX configuration for the cell.

In aspect 24, the method of any of aspects 17-23 further includes that a DTX configuration in the multiple DTX configurations includes a configuration for non-active periods, a first active period associated with a first power spectral density level, and a second active period associated with a second power spectral density level.

In aspect 25, the method of any of aspects 17-24 further includes that at least one DTX configuration in the multiple DTX configurations includes a configuration for non-active periods and active periods associated with a power spectral density level.

In aspect 26, the method of any of aspects 17-25 further includes that an application time for the first DTX configuration is based on a defined time gap relative to the indication or an indicated time gap.

In aspect 27, the method of aspect 26 further includes that the application time is a function of a subcarrier spacing (SCS).

In aspect 28, the method of any of aspects 17-27 further includes that skipping the PDCCH includes skipping providing the PDCCH to the UE in each search space during the non-active period of the first DTX configuration.

In aspect 29, the method of any of aspects 17-28, further comprising: skipping providing configured reference signals in the cell during the non-active period of the first DTX configuration for the cell.

In aspect 30, the method of aspect 29, further comprising: providing at least one of a synchronization signal block (SSB) or a tracking reference signal (TRS) of the cell during the non-active period.

In aspect 31, the method of any of aspects 17-30 further includes that the cell is a first cell associated with a first beam, and the method further comprising: transmitting communication on a second beam associated with a second cell using power sharing based the non-active period of the DTX configuration for the first cell.

In aspect 32, the method of any of aspects 17-31 further includes that the network node is a non-terrestrial network (NTN) node.

In aspect 33, the method of any of aspects 17-32 wherein the activation indication of the first DTX configuration is a first activation indication, and the method further includes providing a deactivation indication for the first DTX configuration and a second activation indication of a second DTX configuration from the multiple DTX configurations; and skipping transmission of the PDCCH during one or more non-active periods of the second DTX configuration.

Aspect 34 is a method of wireless communication at a user equipment (UE), comprising: receiving an indication of multiple discontinuous transmission (DTX) configurations for a cell; receiving an deactivation indication for a first DTX configuration and an activation indication of a second DTX configuration; and skipping monitoring for a physical downlink control channel (PDCCH) during a non-active period of the second DTX configuration.

Aspect 35 is a method of wireless communication at a network node, comprising: providing an indication of multiple discontinuous transmission (DTX) configurations for a cell; providing an deactivation indication for a first DTX configuration and an activation indication of a second DTX configuration; and skipping transmission of a physical downlink control channel (PDCCH) during a non-active period of the second DTX configuration.

Aspect 36 is an apparatus for wireless communication at a UE, comprising: one or more memories; and one or more processors coupled to the one or more memories and configured, individually or in any combination, to cause the UE to perform the method of any of aspects 1 to 16 or 34.

Aspect 37 is an apparatus for wireless communication at a UE, comprising means for performing each step in the method of any of aspects 1 to 16 or 34.

Aspect 38 is UE comprising: a processing system that includes processor circuitry and memory circuitry that stores code and is coupled with the processor circuitry, the processing system configured to cause the UE to: perform the method of any of aspects 1 to 16 or 34.

Aspect 39 is the apparatus of any of aspects 36-38, further comprising a transceiver configured to receive or to transmit in association with the method of any of aspects 1 to 16 or 34.

Aspect 40 is a computer-readable storage medium (e.g., a non-transitory computer-readable storage medium) storing computer executable code at a UE, the code when executed by at least one processor causes the UE to perform the method of any of aspects 1 to 16 or 34.

Aspect 41 is an apparatus for wireless communication at a network node, comprising: one or more memories; and one or more processors coupled to the one or more memories and configured to cause the network node to perform the method of any of aspects 17-33 or 35.

Aspect 42 is an apparatus for wireless communication at a network node, comprising means for performing each step in the method of any of aspects 17-33 or 35.

Aspect 43 is a network entity comprising: a processing system that includes processor circuitry and memory circuitry that stores code and is coupled with the processor circuitry, the processing system configured to cause the network entity to: perform the method of any of aspects 17-33 or 35.

Aspect 44 is the apparatus of any of aspects 41-43, further comprising a transceiver configured to receive or to transmit in association with the method of any of aspects 17-33 or 35.

Aspect 45 is a computer-readable storage medium (e.g., a non-transitory computer-readable storage medium) storing computer executable code at a network node, the code when executed by at least one processor causes the network node to perform the method of any of aspects 17-33 or 35.

What is claimed is:

1. An apparatus for wireless communication at a user equipment (UE), comprising:
one or more memories; and
one or more processors coupled to the one or more memories, wherein the one or more processors are configured to cause the UE to:
receive an indication of multiple discontinuous transmission (DTX) configurations for a cell;
receive an activation indication for a first DTX configuration from the multiple DTX configurations for the cell; and
skip monitoring for a physical downlink control channel (PDCCH) in a non-active period of the first DTX configuration.

2. The apparatus of claim 1, wherein the indication of the multiple DTX configurations is in one or more of:
a broadcast message,
at least one UE specific message, or
group common signaling that is common to multiple UEs.

3. The apparatus of claim 1, wherein the indication indicates the multiple DTX configurations from a set of defined DTX configurations.

4. The apparatus of claim 1, wherein the activation indication is in at least one of a broadcast message, a UE specific message, or group common signaling that is common to multiple UEs.

5. The apparatus of claim 1, wherein the activation indication also indicates a deactivation of a currently activated DTX configuration for the cell.

6. The apparatus of claim 1, wherein the activation indication of the first DTX configuration is a first activation indication, and wherein the one or more processors are further configured to cause the UE to:
receive an deactivation indication for the first DTX configuration and a second activation indication of a second DTX configuration; and
skip monitoring for the PDCCH in one or more non-active periods of the second DTX configuration.

7. The apparatus of claim 1, wherein at least one DTX configuration in the multiple DTX configurations includes:
a first configuration for non-active periods, a first active period associated with a first power spectral density level, and a second active period associated with a second power spectral density level, or
a second configuration for non-active periods and active periods associated with a power spectral density level.

8. The apparatus of claim 1, wherein an application time for the first DTX configuration is based on a defined time gap relative to the indication or an indicated time gap.

9. The apparatus of claim 8, wherein the application time is a function of a subcarrier spacing (SCS).

10. The apparatus of claim 1, further comprising:
one or more antennas coupled to the one or more processors, wherein to skip monitoring the PDCCH, the one or more processors are configured to cause the UE to skip monitoring the PDCCH in all search spaces in the non-active period of the first DTX configuration.

11. The apparatus of claim 1, wherein the one or more processors are further configured to cause the UE to:
skip reception of configured reference signals in the non-active period of the first DTX configuration for the cell.

12. The apparatus of claim 11, wherein the configured reference signals includes a channel state information reference signal (CSI-RS) in the non-active period.

13. The apparatus of claim 12, wherein the one or more processors are further configured to cause the UE to:
monitor for at least one of a synchronization signal block (SSB) or a tracking reference signal (TRS) during the non-active period.

14. An apparatus for wireless communication at a network node, comprising:
one or more memories; and
one or more processors coupled to the one or more memories, wherein the one or more processors are configured to cause the network node to:
provide an indication of multiple discontinuous transmission (DTX) configurations for a cell;
provide an activation indication for a first DTX configuration from the multiple DTX configurations for the cell; and
skip transmission of a physical downlink control channel (PDCCH) to a group of all user equipment (UEs) during a non-active period of the first DTX configuration.

15. The apparatus of claim 14, wherein a DTX configuration in the multiple DTX configurations includes:
a first configuration for non-active periods, a first active period associated with a first power spectral density level, and a second active period associated with a second power spectral density level, or
a second configuration for non-active periods and active periods associated with a power spectral density level.

16. The apparatus of claim 14, wherein an application time for the first DTX configuration is based on a defined time gap relative to the indication or an indicated time gap.

17. The apparatus of claim 14, further comprising:
one or more antennas coupled to the one or more processors, wherein to skip the PDCCH, the one or more processors are configured to cause the network node to skip one or more of:
transmission of the PDCCH in each search space during the non-active period of the first DTX configuration, or
transmission of configured reference signals in the cell during the non-active period of the first DTX configuration for the cell.

18. The apparatus of claim 14, wherein the cell is a first cell associated with a first beam, and wherein the one or more processors are further configured to cause the network node to:
transmit communication on a second beam associated with a second cell using power sharing based the non-active period of the DTX configuration for the first cell.

19. The apparatus of claim 14, wherein the network node is a non-terrestrial network (NTN) node.

20. The apparatus of claim 14, wherein the activation indication of the first DTX configuration is a first activation indication, and wherein the one or more processors are further configured to cause the network node to:
provide a deactivation indication for the first DTX configuration and a second activation indication of a second DTX configuration from the multiple DTX configurations; and
skip transmission of the PDCCH in one or more non-active periods of the second DTX configuration.
